(19) United States
(12) Patent Application Publication
(10) Pub. No.: US 2025/0176754 A1
(43) Pub. Date: Jun. 5, 2025

(54) DEVICE FOR FROTHING MILK

(71) Applicant: DE' LONGHI APPLIANCES S.r.l., Treviso (IT)

(72) Inventors: Antonio PANCIERA, Treviso (IT); Simone ROSETTA, Treviso (IT); Eros SARTORI, Treviso (IT)

(73) Assignee: DE' LONGHI APPLIANCES S.r.l., Treviso (IT)

(21) Appl. No.: 18/862,051

(22) PCT Filed: Apr. 6, 2023
(86) PCT No.: PCT/EP2023/059131

§ 371 Date: Oct. 31, 2024

(30) Foreign Application Priority Data
May 9, 2022 (IT) 102022000009536

(51) Int. Cl. A47J 31/44

(52) U.S. Cl. CPC A47J 31/4485; A47J 31/4407

(57) ABSTRACT

A device for frothing milk comprises: a milk container and a lid removably connected to the milk container, where the lid is provided with an external milk dispenser and houses a manifold body having a Venturi-effect air suction opening and a Venturi-effect milk suction opening, and a steam injector in the manifold body for triggering the Venturi effect, the device further comprising a tube for collecting milk from the container which can be separated into a first truncated tube connected to the container and a second truncated tube connected to the lid and communicating with the milk suction opening.

### CROSS-REFERENCE TO RELATED APPLICATIONS

This is a U.S. National Phase Application under 35 U.S.C. 371 of International Patent Application No. PCT/EP2023/059131, filed Apr. 6, 2023, which claims benefit of priority to Italian Patent Application No. 102022000009536, filed May 9, 2022. The entire contents of these applications are hereby incorporated by reference.

### FIELD OF THE INVENTION

The present invention refers to a device for frothing milk.

### BACKGROUND

Device for frothing milk that can be associated with a coffee machine have long been known. Some types of known devices comprise a milk container provided with a lid incorporating a Venturi-effect mixing chamber where air and milk collected from the container are mixed by Venturi-effect triggered by a steam flow.

Such known devices for frothing milk may complain of drawbacks including the complexity of accessing internal components for inspection and cleaning.

This problem is quite relevant if one thinks that any milk residues that solidify inside the device can create blockages of the milk flow passage openings and thus alter the efficiency of the device.

Last but not least, milk residues that solidify inside the device can also negatively affect the organoleptic characteristics of the product and generate unpleasant malodorous exhalations.

For this reason, such devices can provide for the injection of liquid detergents for washing the internal parts which obviously must be carefully rinsed.

The technical task of the present invention is therefore to realize a device for processing a device for frothing milk which makes it possible to eliminate the decried technical drawbacks of the prior art.

Within the context of this technical task, an object of the invention is to realize a device for frothing milk that can be easily inspected and cleaned.

### SUMMARY

The technical task, as well as these and other objects, according to the present invention are achieved by realizing a device for frothing milk comprising: a milk container and a lid removably connected to said milk container, where the lid is provided with an external milk dispenser and houses a manifold body having a Venturi-effect air suction opening and a Venturi-effect milk suction opening, and a steam injector in the manifold body for triggering the Venturi effect, characterized in that it comprises a tube for collecting milk from the container which can be separated into a first truncated tube connected to said container and a second truncated tube connected to said lid and communicating with said milk suction opening.

The construction of the device for frothing milk is particularly advantageous in that, simply by providing a kit of two or more milk containers to be associated each time with the lid depending on the type of milk (for example animal or vegetable) used, allows to minimize the risk of contamination, between the milk beverages obtained from subsequent dispensings; this in contrast to what happens in traditional devices in which the same milk suction conduit is always the one that, by dipping into the milk present each time in the milk container, contaminates a milk beverage with residues of the milk beverage produced in the previous preparation cycle.

In an embodiment of the invention said milk collection tube has at said second truncated tube a calibrated minimum milk passage opening.

In an embodiment of the invention said first truncated tube is formed in one piece with said container.

In an embodiment of the invention said first truncated tube extends vertically from a bottom of said container at which it has a milk inlet route.

In an embodiment of the invention said lid has a first part and a second part which are removably engageable, where said first part of lid houses said manifold body and said second part of lid houses said steam injector.

In an embodiment of the invention said steam injector comprises an injection conduit having a first terminal for coupling connection in said manifold body and a second terminal for coupling connection with a steam dispenser.

In an embodiment of the invention said first connection terminal and said second connection terminal have transverse coupling axes.

In an embodiment of the invention said transverse coupling axes are horizontal.

In an embodiment of the invention said injection conduit has a 90° bend.

In an embodiment of the invention said lid houses a conduit for collecting air from the external atmospheric environment, where said air collection conduit is connected to said air suction opening and comprises a first air collection conduit housed in said first part of lid and a second air collection conduit housed in said second part of lid.

In an embodiment of the invention said first part of air collection conduit and said second part of air collection conduit have mutual connection terminals having a coupling axis parallel to the coupling axis of said first connection terminal of said steam injection conduit.

In an embodiment of the invention said first part of lid has a portion for closing the milk container surmounted by a compartment for housing said second part of lid.

In an embodiment of the invention said compartment matches the external outline of said second part of lid.

In an embodiment of the invention said compartment has walls for guiding the sliding of said second part of lid in the direction of said coupling axis of said first terminal.

In an embodiment of the invention said compartment is configured like an insertion slot of said second part of lid.

### BRIEF DESCRIPTION OF THE DRAWINGS

Further features and advantages of the invention will become more apparent from the description of a non-exclusive embodiment thereof, of the device for frothing milk according to the invention, which is illustrated by way of non-limiting example in the drawings, in which:

FIG. 1 shows a front view of a coffee machine including the device for frothing milk;

FIG. 2 shows a front view of the coffee machine of FIG. 1 from which the device for frothing milk was removed;

FIGS. 3 and 4 show axonometric views of the device for frothing milk;

FIGS. 5 and 6 show the device for frothing milk with the lid separated from the milk container;

FIGS. 7 and 8 show the device for frothing milk, with the lid separated from the milk container and broken down into the two parts of lid;

FIG. 9 shows a vertical section of the device for frothing milk;

FIG. 10 shows a vertical section of the device for frothing milk with the lid separated from the milk container;

FIG. 11 shows a vertical section of the device for frothing milk with the lid separated from the milk container and from which the second part of lid has been removed;

FIG. 12 shows in perspective the second part of the lid;

FIG. 13 shows a plan view of the second part of the lid sectioned in a horizontal plane;

FIGS. 14a, 14b illustrate in perspective a variant of the milk container with the bottom openable for access to the lower end of the milk collection tube;

FIG. 15 shows inside elevation a vertical section of the milk container of FIGS. 14a, 14b with the bottom in open configuration of access to the lower end of the milk collection tube; and

FIG. 16 shows inside elevation a vertical section of the milk container of FIGS. 14a, 14b with the bottom in closed configuration.

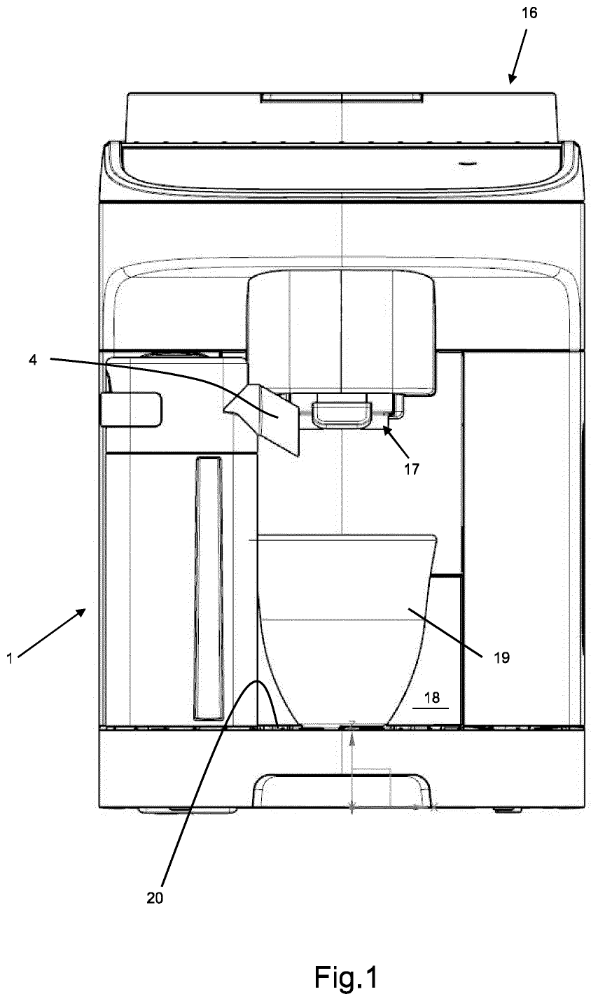

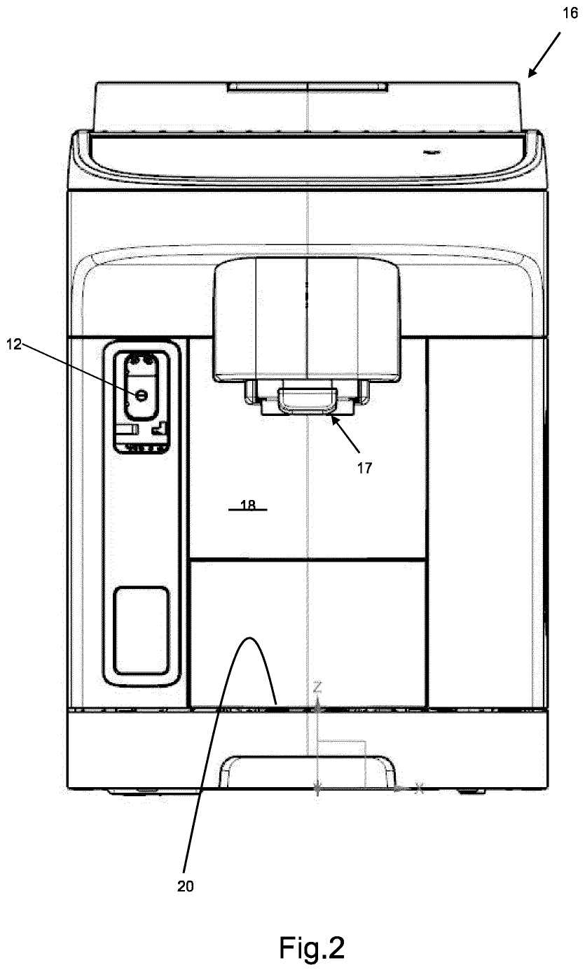

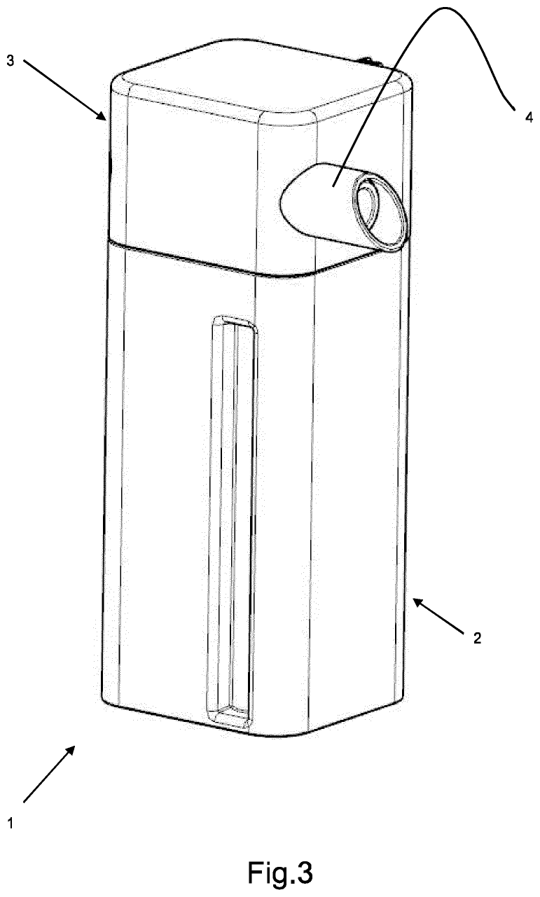

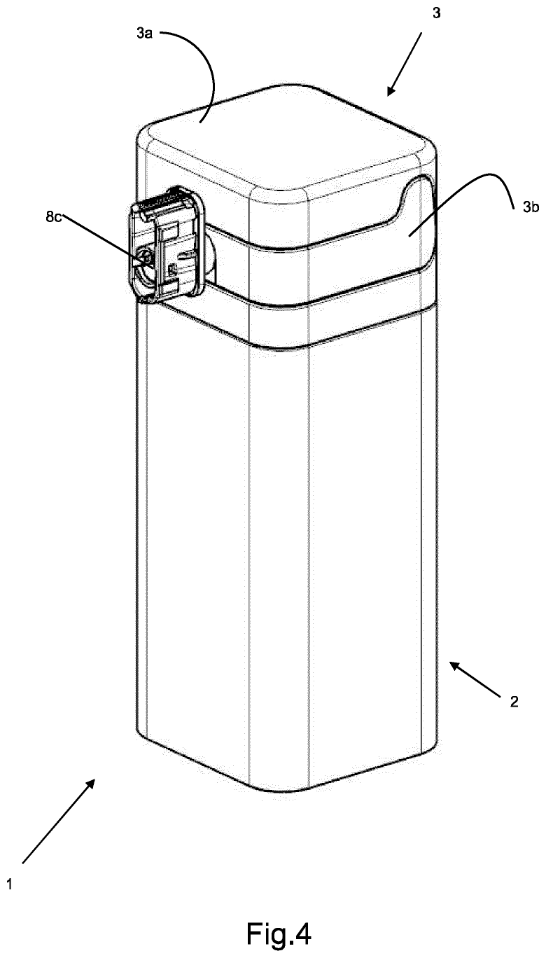

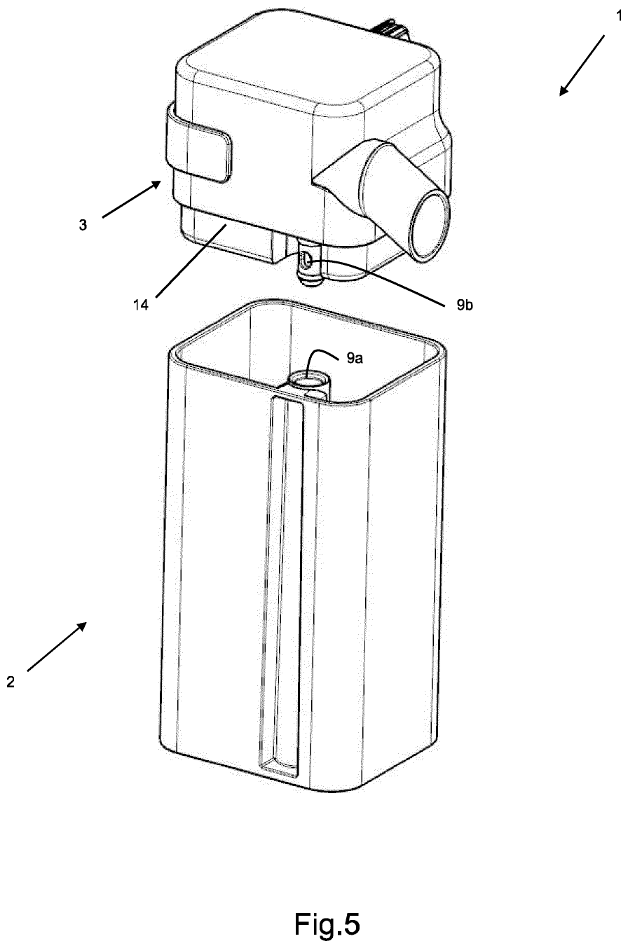

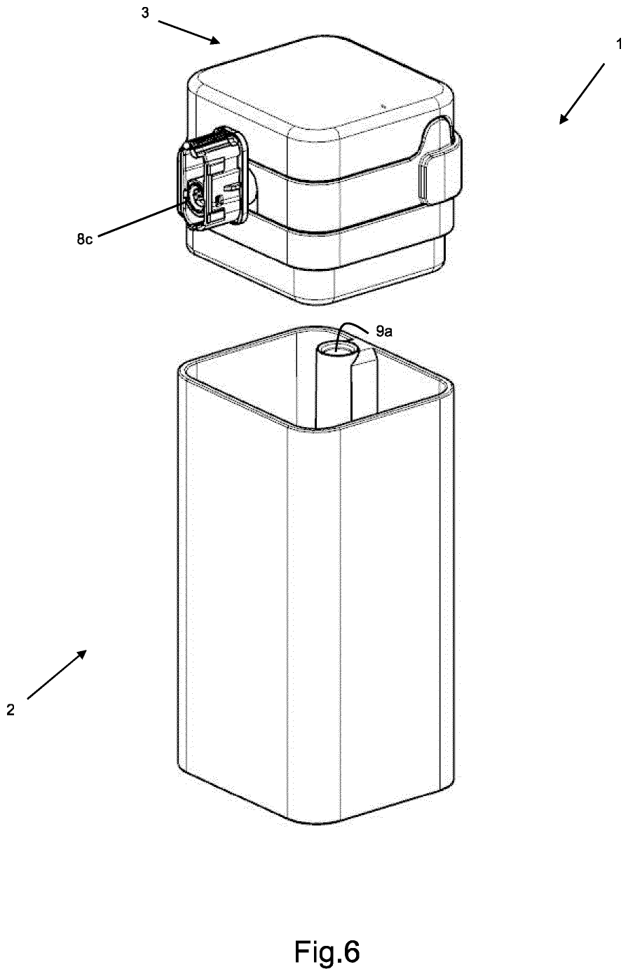

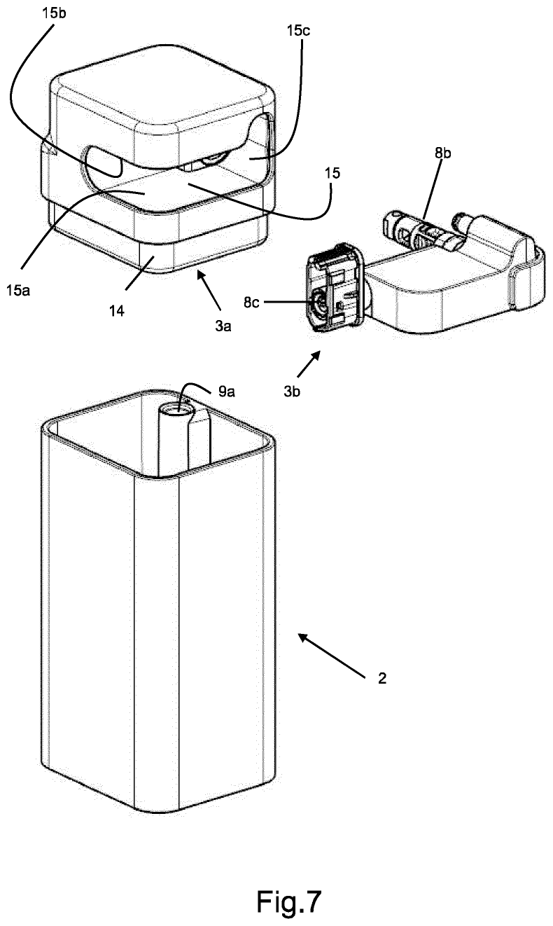

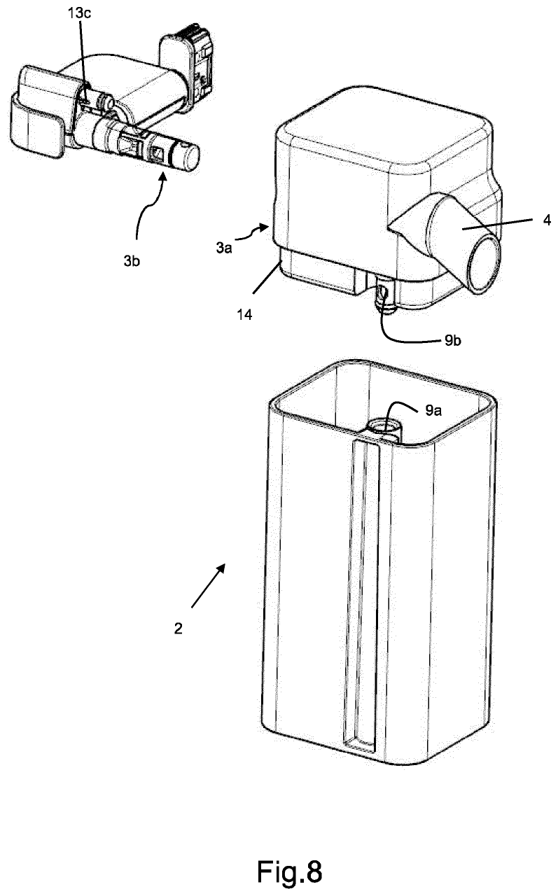

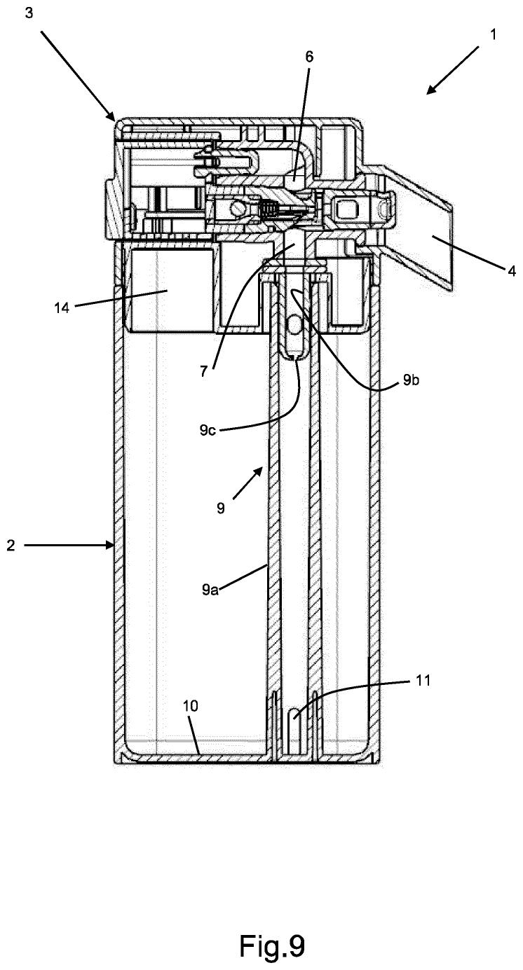

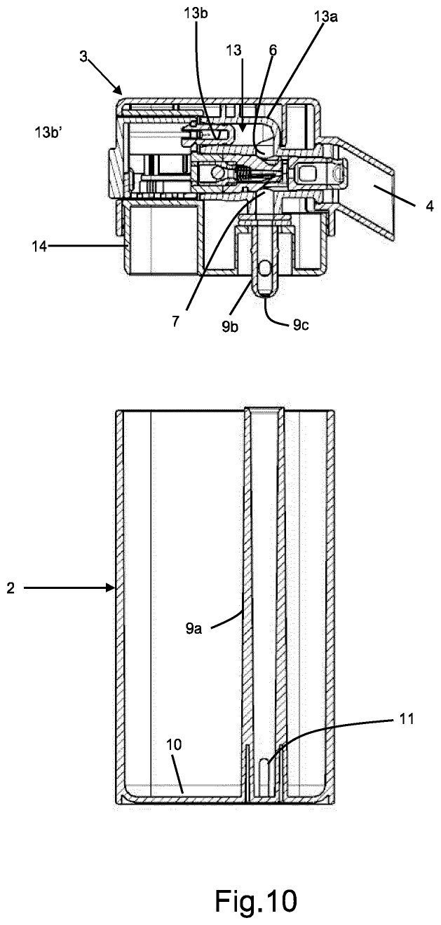

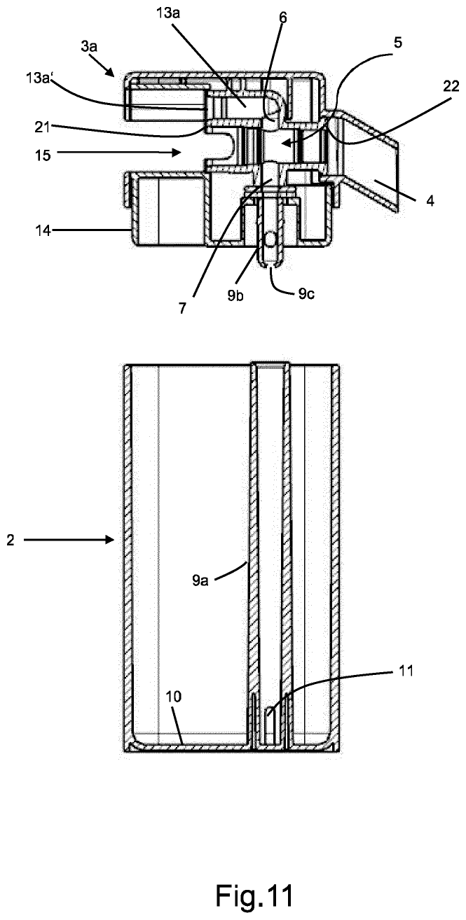

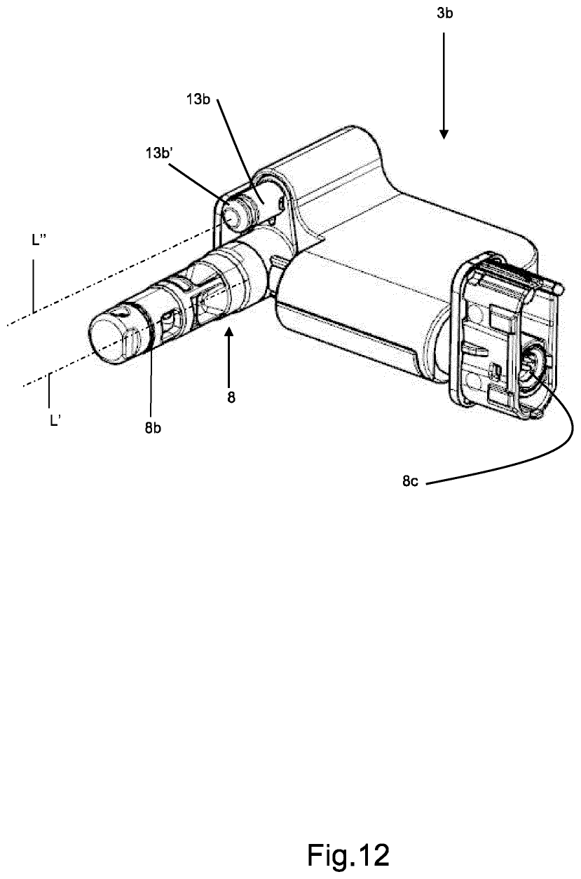

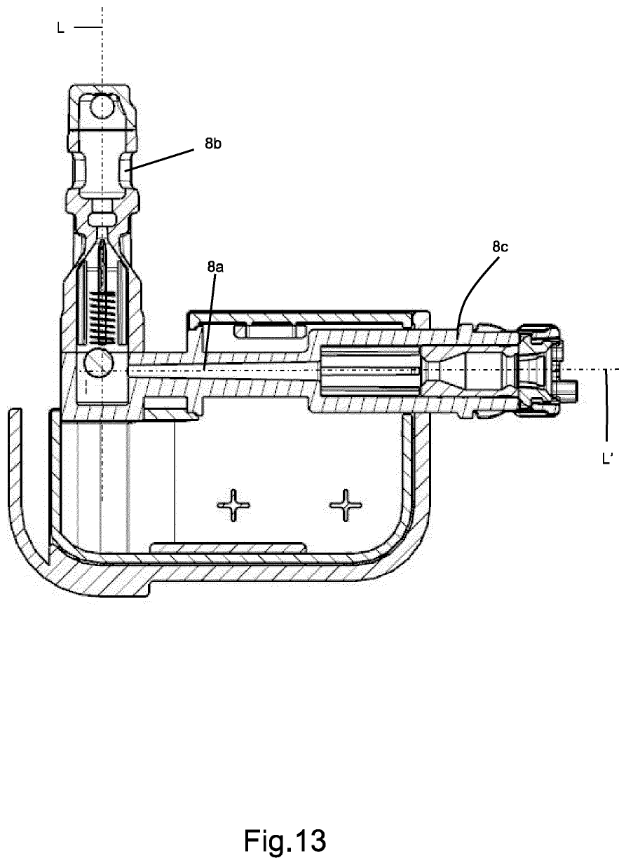

### DETAILED DESCRIPTION

With reference to the aforementioned figures, a device for frothing milk indicated as a whole with reference numeral 1 is shown.

The device 1 comprises a milk container 2 provided with a removable closure lid 3.

The lid 3 can be removed from the container 2 to refill the container 2 with fresh milk once it is empty.

The lid 3 in turn is provided with an external milk dispenser 4.

The lid 2 has a hollow structure to house inside it, as we will see, some components of the device 1.

The lid 3 in fact houses a manifold body 5 having a Venturi-effect air suction opening 6 and a Venturi-effect milk suction opening 7.

The lid 3 also houses a steam injector 8 in the manifold body 5 for triggering the Venturi effect. Advantageously, the device 1 comprises a tube for collecting milk 9 from the container 2, which can be separated into a first truncated tube 9a connected to the container 2 and a second truncated tube 9b connected to the lid 3 and communicating with the milk suction opening 7.

The second truncated tube 9b connected to the lid 3 extends vertically and has a vertical upward outlet route communicating with the milk suction opening 7.

A calibrated minimum milk passage opening 9c along the milk collection tube 9c is advantageously formed in the second truncated tube 9b of the milk collection tube 9c.

The first truncated tube 9a of the milk collection tube 9 is formed in a single piece with the container 2.

The milk collection tube 9 extends inside the milk container 9 and in particular the first truncated tube 9a of the milk collection tube 9 extends vertically from a bottom 10 of the milk container 2 at which it has a milk inlet route 11.

The lid 3 has a first part 3a and a second part 3b which are removably engageable.

The first part of lid 3a houses the manifold body 5 while the second part of lid 3b houses the steam injector 8.

The steam injector 8 comprises an injection conduit 8a having a first terminal 8b for coupling connection in the manifold body 5 and a second terminal 8c for coupling connection with a steam dispenser 12.

Typically the steam dispenser 12 is the one commonly available in a coffee machine 16.

The first connection terminal 8b and the second connection terminal 8c of the steam injector 8 have transverse coupling axes L, L′.

In particular, the transverse coupling axes L, L′ of the first connection terminal 8b and of the second connection terminal 8c of the steam injector 8 are horizontal.

The injection conduit 8a of the steam injector 8 has a 90° bend connecting the first connection terminal 8b and the second connection terminal 8c.

The lid 3 houses a conduit for collecting air 13 from the external atmospheric environment.

The air collection conduit 13 is connected to the air suction opening 6 and comprises a first part of air collection conduit 13a housed in the first part of lid 3a and a second part of air collection conduit 13b housed in the second part of lid 3b.

The air collection conduit 13 has, at the second part of air collection conduit 13b, a calibrated air inlet opening 13c that puts the air collection conduit 13 in communication with the atmospheric environment outside the device 1.

The first part of air collection conduit 13a and the second part of air collection conduit 13b have terminals 13a′, 13b′ for mutual coupling connection having a coupling axis L″ parallel to the coupling axis L of the first connection terminal 8b of the steam injection conduit 8a.

The first part of lid 3a has a portion 14 for closing the milk container 2 surmounted by a housing compartment 15 of the second part of lid 3b.

The compartment 15 matches with the external outline of the second part of lid 3b.

The compartment 15 has walls 15a, 15b, 15c for guiding the sliding of the second part of lid 3b in the direction of the coupling axis L of the first terminal 8b of the steam injector 8.

The compartment 15 is configured like an introduction slot of the second part of lid 3b.

The first part of lid 3a comprises at least two pieces, of which a first rubber piece, for example silicone, and a second stiffer piece for example plastic or metal, where the first piece comprises the manifold body 5, the first part of air collection conduit 13a, and the second truncated tube 9b of the milk collection tube 9, while the second stiffer piece comprises an external shell including the external milk dispenser 4 and the portion 14 for closing the container 2.

The first rubber piece further comprises a fitting 21 for coupling connection of the steam injector 8 with the manifold body 5 for accessing the steam in the manifold body 5 and a fitting 22 for coupling connection of the external milk dispenser 4 with the manifold body 5 for the exit of the frothed milk from the manifold body 5.

The provision of a coupling connection between a part made of soft material and a part made of stiffer material ensures fluid tightness.

In particular, fluid tightness is ensured in the coupling connection: between the second truncated tube 9b, typically made of rubber, and the first truncated tube 9a, typically made of plastic, of the milk collection tube 9; between the fitting 21, typically made of rubber, and the steam injector 8, typically made of plastic or metal; between the first part of air collection conduit 13a, typically made of rubber, and the second part of air collection conduit 13b, typically made of plastic; and between the fitting 22, typically made of rubber, and the external milk dispenser 4, typically made of plastic or metal.

In an exemplary embodiment solution, the passage opening of the first truncated tube 9a of the tube 9 for collecting milk 9 has a diameter comprised between about 8 mm and 14 mm to allow easy cleaning with water or a brush.

The second truncated tube 9b of the milk collection tube 9 has an external diameter comprised between 8.5 and 14.5 mm to facilitate the coupling connection with the first truncated tube 9a of the milk collection tube 9.

The calibrated minimum milk passage opening 9c has a diameter comprised between 0.5 mm and 2 mm.

The size of the calibrated minimum milk passage opening 9c determines the flow rate of the milk sucked from the container 2 through Venturi effect triggered by the steam and therefore the ratio between steam flow and milk flow.

For example, a calibrated minimum milk passage opening 9c having a diameter of 0.7 mm can allow the suction of a milk flow of about 150 ml/min which is heated from 5° C. to 60° C. thanks to the heat exchange with the steam which will then be present in condensed form in the product dispensed by the external milk dispenser 4 with a weight comprised between 10% and 30% of the weight of the dispensed product.

In addition, the calibrated air inlet opening 13c has an equivalent diameter comprised between 0.1 mm and 0.4 mm so as to allow an air suction from 2 cc/s to 8 cc/s useful for frothing the milk.

The device 1 can be fed, as mentioned, by a steam dispenser 12, typically a nozzle normally provided in a coffee machine 16.

The steam dispenser 12 extends with horizontal axis in front-rear direction of the coffee machine 16.

The coffee machine 16 usually has a hydraulic circuit (not shown) which provides in cascade a water source, a water supply pump, a boiler and an infuser.

The hydraulic circuit of the coffee machine 16 also comprises a steam production line having the steam dispenser 12 as a terminal.

The water source can be a tank integrated into the coffee machine or a connection to the water mains.

The infuser is connected to an external coffee dispenser 17 supported by a front wall 18 of the coffee machine 16.

The steam dispenser 12 projects horizontally from the front wall 18 of the coffee machine 16. The external coffee dispenser 17 can dispense directly into a cup 19 below positioned on a front surface 20 for resting cups of the coffee machine 16.

When connected to the coffee machine 16 the device 1 is positioned in front of the front wall 18 of the coffee machine 16 and the steam dispenser 18 is coupled in the second terminal 8c of the steam injector 8.

In the connection position the container 2 rests on the cup rest surface 20 and the external dispenser 4 can dispense directly into the cup 19.

The cup rest surface 20 can be used as a guide for a horizontal movement of connection of the device 1 to the coffee machine 16.

The operation of the device 1 according to the invention is evident from what is described and illustrated and, in particular, is substantially the following.

The steam flow triggers a Venturi effect through which milk and air are sucked into the manifold body 5.

The steam flow recalls through Venturi effect a milk flow to which it provides a supply of thermal energy that results in an increase in temperature of the milk to be dispensed in the cup.

The same steam flow recalls through Venturi effect, an air flow useful for frothing the milk to be dispensed in the cup.

The user can very easily disassemble the device 1 for cleaning.

In particular, access to the milk collection tube 9 can be performed with extreme simplicity: first of all, the device 1 is disconnected from the coffee machine 16 by removing the steam injector 8 from the external steam dispenser 12 by means of a horizontal pulling force in the direction of the axis L.

At this point the lid 3 is lifted from the container 2 by exerting a pulling force on the lid 3 until complete disconnection between the two truncated tubes 9a, 9b of the milk collection tube 9.

Finally, the second part 3b of the lid 3 is extracted from the first part 3a of the lid 3 by exerting a pulling force on the second part 3b of the lid 3 in the direction of the parallel axes L, L″ until complete disconnection between the two parts.

The cleaning components of the disassembled device 1 can be done in the dishwasher or by hand with water, special detergents and possibly a brush to be inserted along the first truncated tube 9a of the milk collection tube 9.

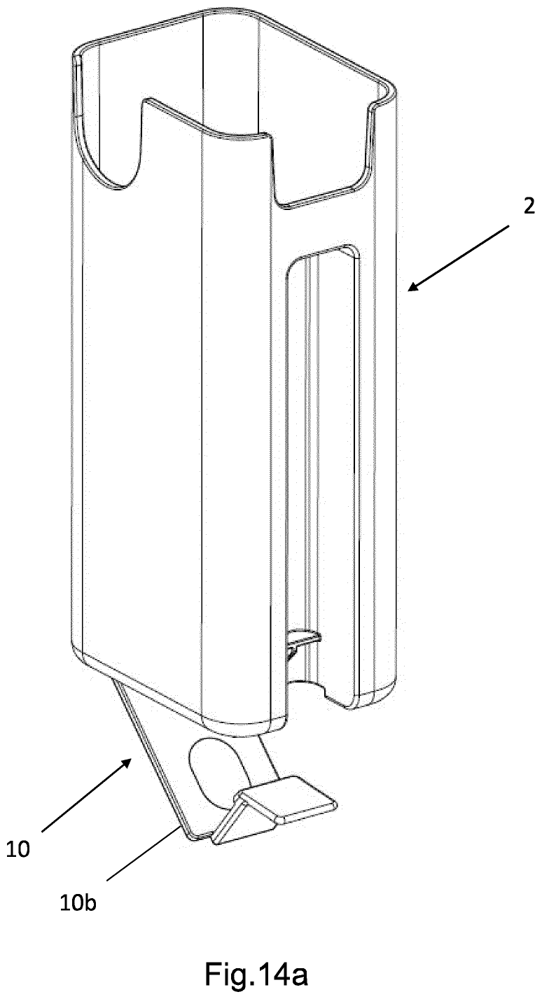

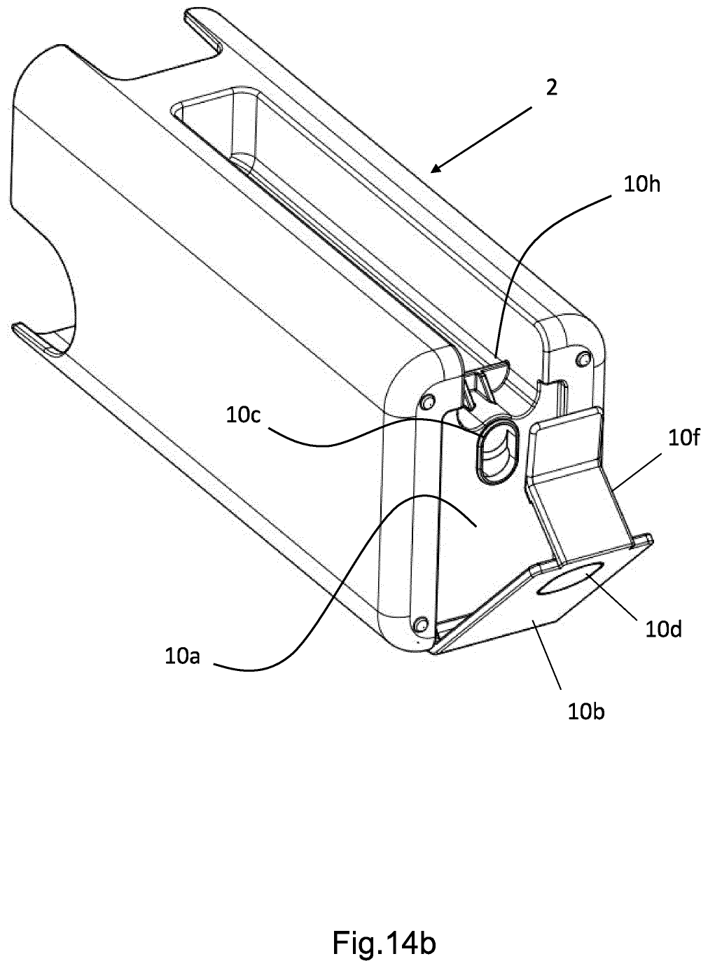

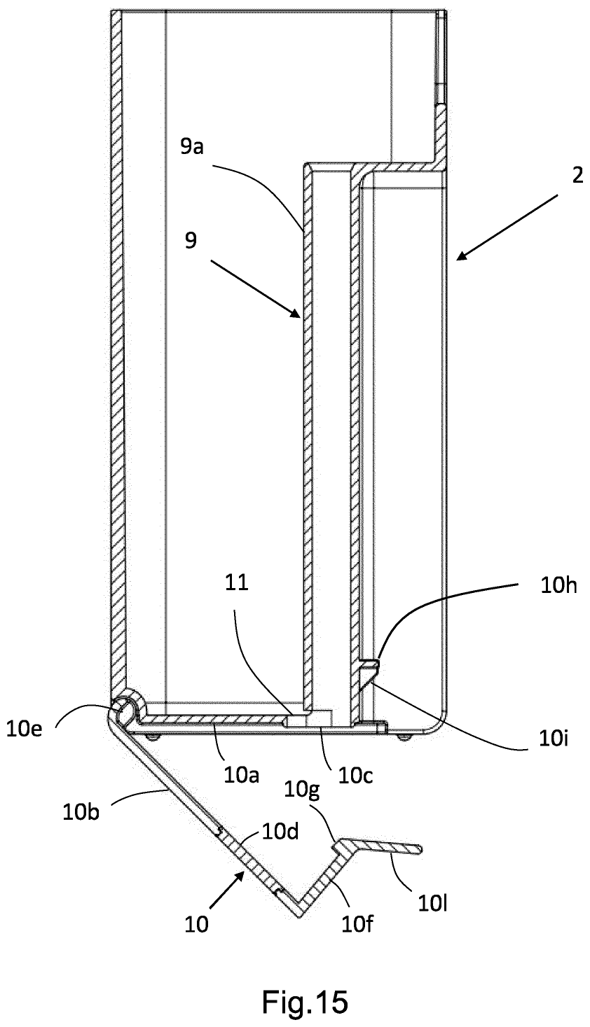

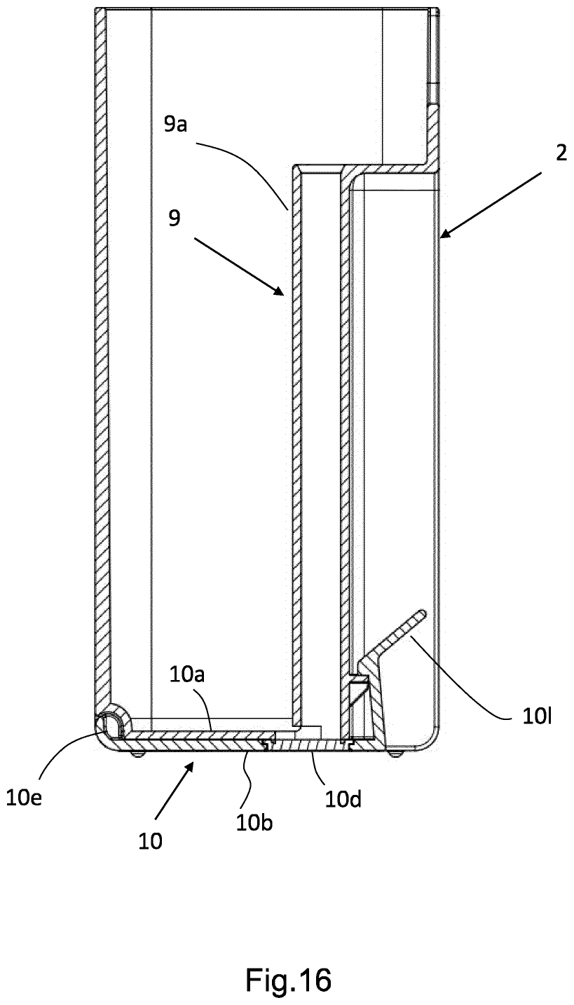

FIGS. 14a-16 show a variant of the milk container 2 with the bottom 10 openable for access to the lower end of the milk collection tube 9.

This makes it possible to further improve inspection and cleaning operations.

The bottom 10 in this case advantageously provides a fixed internal wall 10a and a movable external wall 10b.

The fixed internal wall 10a has a through hole 10c facing the lower end of the milk collection tube 9.

The movable external wall 10b has a rubber insert 10d sealingly engageable with the through hole 10c of the fixed internal wall 10a for closing the same.

The movable external wall 10b is pivoted to the milk container 2 through a pin 10e to oscillate between an opening position and a closed position of the through hole 10c.

From an edge of the movable external wall 10b there extends at an angle a flexible lever 10f for actuating a tooth 10g engageable snap-fittingly in a coupling seat 10h provided on the external side of the side wall of the milk container 2 to lock the movable external wall 10b in the closed position of the through hole 10c of the fixed internal wall 10a.

During the closing movement of the movable external wall 10b, the tooth 10g slidingly engages along an inclined plane 10i which causes the lever 10f to bend: when it climbs over the inclined plane 10h, the tooth 10g snaps into the coupling seat 10h.

To release the coupling tooth 10g from the coupling seat 10g and thus unlock the movable external wall 10b, the flexible lever 10f has an angled hand grip end 101.

The conceived device for frothing milk is susceptible to numerous modifications and variations, all falling within the scope of the inventive concept; moreover, all the details can be replaced by technically equivalent elements.

In practice, the materials used, as well as the dimensions, can be any depending on the needs and the state of the art.

1. A device for frothing milk comprising: a milk container, a lid removably connected to said milk container, where the lid is provided with an external milk dispenser and houses a manifold body having a Venturi-effect air suction opening and a Venturi-effect milk suction opening, and a steam injector in the manifold body for triggering the Venturi effect, the device further comprising a tube for collecting milk from the container which can be separated into a first truncated tube connected to said container and a second truncated tube connected to said lid and communicating with said milk suction opening.

2. The device for frothing milk according to claim 1, wherein said first truncated tube is formed in a single piece with said container and extends vertically from a bottom of said container at which it has a milk inlet route and said second truncated tube extends vertically and has an upward vertical outlet route communicating with said milk suction opening.

3. The device for frothing milk according to claim 1, wherein said milk collection tube has at said second truncated tube (9b) a calibrated minimum milk passage opening.

4. The device for frothing milk according to claim 1, wherein said lid has a first part and a second part which are removably engageable, where said first part of lid houses said manifold body and said second part of lid houses said steam injector.

5. The device for frothing milk according to claim 1, wherein said steam injector comprises an injection conduit having a first terminal for coupling connection in said manifold body and a second terminal for coupling connection with a steam dispenser.

6. The device for frothing milk according to claim 5, wherein said first connection terminal and said second connection terminal have transverse coupling axes.

7. The device for frothing milk according to claim 6, wherein said transverse coupling axes are horizontal.

8. The device for frothing the milk according to claim 6, wherein said injection conduit has a 90° bend.

9. The device for frothing milk according to claim 1, wherein said lid houses a conduit for collecting air from the external atmospheric environment, where said air collection conduit is connected to said air suction opening and comprises a first part of air collection conduit housed in said first part of lid and a second part of air collection conduit housed in said second part of lid.

10. The device for frothing milk according to claim 9, wherein said first part of air collection conduit and said second part of air collection conduit have mutual connection terminals having a coupling axis parallel to the coupling axis of said first connection terminal of said injection conduit.

11. The device for frothing milk according to claim 4, wherein said first part of lid has a portion for closing the milk container surmounted by a compartment for housing said second part of lid.

12. The device for frothing milk according to claim 11, wherein said compartment matches the external outline of said second part of lid.

13. The device frothing milk according to claim 12, wherein said compartment has walls for guiding the sliding of said second part of lid in the direction of said coupling axis of said first terminal.

14. The device for frothing milk according to claim 13, wherein said compartment is configured as an introduction slot of said second part of lid.

15. The device for frothing milk according to claim 2, wherein the bottom of said milk container has an openable and reclosable through hole facing the lower end of said milk collection tube.
